(19) United States
(12) Patent Application Publication
(10) Pub. No.: US 2005/0210750 A1
(43) Pub. Date: Sep. 29, 2005

(54) Motor vehicle window removal system

(76) Inventors: Lonny MacDougall, Phoenix, AZ (US); Edward H. Arnold JR., Arroyo Grande, CA (US)

Correspondence Address: Steven Thrasher, 391 Sandhill Dr., Richardson, TX, 75080, US

(21) Appl. No.: 10/811,022

(22) Filed: Mar. 25, 2004

(51) Int. Cl. E05B 65/10; E05C 3/16

(52) U.S. Cl. 49/141

(57) ABSTRACT

The invention is a quick-remove window system that provides for the rapid removal of a window from a motor vehicle. In one embodiment, the system alters a window assembly to provide the ability to remove a vehicle window from a vehicle window frame.

### TECHNICAL FIELD

The invention relates to motor vehicles, and, more particularly, the invention relates to motor vehicle windows.

### STATEMENT OF A PROBLEM ADDRESSED BY THIS INVENTION

Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Statement of a Problem Addressed by This Invention is to be construed as prior art.

Discussion

Motor vehicle (vehicle) windows increase aerodynamic performance while providing occupant protection from wind, excessive sun glare, and small objects. For example, modem windows are engineered to complement the shape of the vehicle body to enable the vehicle to “cut” through the air. More than being more visually appealing, this increases fuel efficiency. In addition, tinting can help prevent accidents by protecting occupants from the sun's glare, while the structure of the window prevents pebbles and insects from pelting occupants. To reliably provide these benefits, and to prevent the theft of items in the vehicle, windows are securely mounted to a vehicle. However, the rigid mounting of the window is not without drawbacks. For example, if the vehicle power fails in an accident, an occupant may be trapped in the vehicle even if the window is only partially “up or down”. Sometimes, windows cannot be manually raised or lowered, and, even when they can, the slow speed with which windows raise and lower is far too slow if the vehicle is on fire or sinking in water.

Persons may become trapped in a vehicle due to a wide variety of circumstances. Sometimes, due to poor driving or to poor road conditions, a person may drive a car into a body of water, such as a reservoir, lake, or flooded street, thereby trapping the occupants of the vehicle inside. In yet other circumstances a vehicle occupant may be trapped inside a car as a result of an accident. Occasionally, vehicles catch fire due to electrical problems or as a result of accidents and burn any occupants who are trapped inside. Whether due to fire, flood, or other trapping, vehicle occupants need a means for escape in the event they are trapped inside and face potential danger. Sometimes, doors are pinned against objects, or shutdown due to electromechanical failure, leaving the windows as the only means of escape. Unfortunately, windows are difficult to remove and as unbreakable windows become more common, an occupant will be unable to escape through a window opening by shattering a window. Accordingly, there is a need for inventive systems and devices that enable an occupant to have more control over an escape from a motor vehicle. The present invention provides such a system and device.

### BRIEF DESCRIPTION OF THE DRAWINGS

Various aspects of the invention, as well as at least one embodiment, are better understood by reference to the following EXEMPLARY EMBODIMENT OF A BEST MODE. To better understand the invention, the EXEMPLARY EMBODIMENT OF A BEST MODE should be read in conjunction with the drawings in which:

FIG. 1 shows a quick-remove window system (the window system);

FIG. 2 illustrates a quick-remove window system mounted in a vehicle door;

FIG. 3a is a view of a selected portion the window system, taken to emphasize the support system and the release system;

FIG. 3b provides a cut-view of FIG. 3a taken along cut-line 3b-3b; and

FIG. 3c shows a close-up of the release system by providing a cut-view of FIG. 3a taken along cut line 3c-3c.

### AN EXEMPLARY EMBODIMENT OF A BEST MODE

Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the claims section. The invention is also described in view of the Festo decisions, and, in that regard, the claims and the invention incorporate equivalents known, foreseeable, and unforeseeable.

Discussion of the Figures

The invention can be generally characterized as a system that allows a motor vehicle occupant to remove a door-mounted window, such as a passenger-side or driver-side window of an automobile. In one preferred embodiment, the invention provides a manually operable system that uses a cord to unlock a window support system so that a window may be more easily separated from a window support member. In an alternative embodiment, an actuator is situated proximate to the window support member, and a motor is used to release the support member thus, after the motor releases the window from the support member, an occupant of the motor vehicle can easily remove the window from the support system and then push the window down into the door frame so that the occupant can exit the vehicle through the window frame.

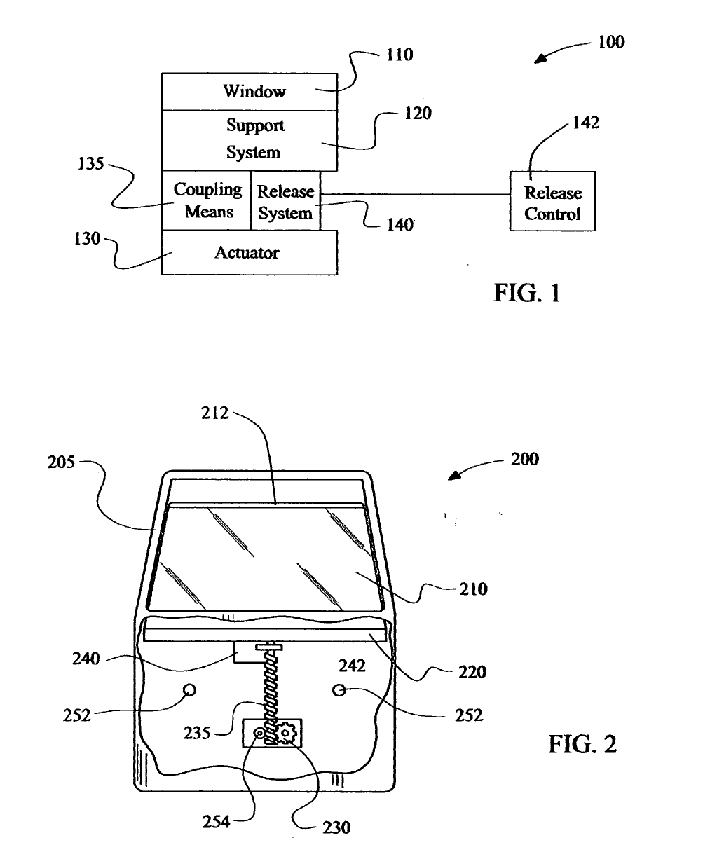

Features and advantages of the invention can be better understood by reviewing the figures, where FIG. 1 shows a quick-release window system (the window system) 100. The window system 100 can generally be functionally characterized as a system that enables a user to adapt a vehicle window so that it can be substantially removed from a vehicle window frame. In the preferred embodiment, the vehicle window is substantially removable, and is adapted to drop/lower into a vehicle doorframe. Of course, the invention has applicability to other window systems, including most fixed or adjustable rear-windows, as well as other vehicle windows, which will become apparent to one of ordinary skill in the art upon reading the present disclosure.

A window system 100 generally includes a vehicle window 110 that is disposed in a vehicle window support system 120. In a preferred embodiment, the vehicle window 110 is a traveling window; that is, the vehicle window 110 is adapted to travel up and down (or from side to side) between a closed position in a vehicle window frame and a predefined open position, either partially or completely out of the vehicle window frame. The window support system 120 may grasp, hold, or otherwise secure the vehicle window 110 so that the vehicle window 110 may travel (either up and down or from side to side) when an actuator 130, such as an electromechanical actuator or window “rolling” handle, moves a coupling means 135, which couples the actuator 130 to the vehicle window 110, in a manner known in the art.

Although well-known prior art support systems are applicable to the invention, the invention preferably incorporates a support system that is adapted to improve the performance of the invention, as discussed below or is available in a functionally equivalent support system. The window system 100 also includes a release system 140 that is coupled to a release control 142. The release system 140 can be generally characterized as a system that adapts another window system element so that the vehicle window 110 can be substantially removed from a vehicle window frame. For the remainder of the discussion, it is understood that references to removing a window mean substantially removing a vehicle widow from a motor vehicle frame to provide a vehicle occupant the ability to exit a motor vehicle through that vehicle window frame.

Typically, the release system 140 is coupled to the window 110 via the support system 120 and/or the coupling means 135, but may also be coupled to the actuator 130. Likewise, the release control 142 is any control device that initiates the window removal such as a push-button, a fire sensor, a water sensor, or a sudden stop sensor, for example.

Moving to a more detailed embodiment, FIG. 2 illustrates a quick-remove window system (the window system) 200 as mounted in a vehicle door. The window system 200 includes a vehicle window frame 205, which generally comprises the portion of the vehicle doorframe into which a vehicle window 210 fits, when in a closed position (the structure and configuration of known devices and systems will be readily apparent to those of ordinary skill in the art). The window frame 205 may include seals, weather and sound insulation, means for guiding a window, and other sub-components as is known in the art.

Preferably, the vehicle window 210 includes a grasping portion 212 which is adapted to enable a person to safely place downward pressure on the vehicle window 210 without shattering or breaking the vehicle window 210, and without cutting the hands of the person placing pressure on the vehicle window 210. Preferably, the grasping portion 212 is a resilient rubber or plastic. However, other materials are readily apparent to those of ordinary skill in the art. The vehicle window 210 is likewise coupled to a support member 220. The support member 220 is adapted to both hold the window 210 through its travel in the vehicle window frame 205, and to move up and down (in this embodiment) via articulation of a coupling means (or linkage) embodied in FIG. 2 as a worm screw 235.

As one may expect, the worm screw 235 is articulated by a an actuator 230, which is illustrated here as a worm screw drive, but may also be any manual or electromechanical articulation means. The actuator 230 and the worm screw 235 operate as is known in the mechanical arts. It is understood that the invention is not limited to worm screw implementations, and has applicability to any window system known in the art, and which may be developed—especially in light of the present disclosure, and encompasses even unforeseeable implementations. In addition, the invention may include guidance and support means, such as rest pins 252 and guide pin 254.

To provide removal functionality to the window system 200, the window system incorporates a release system. The release system generally comprises at least an actuator 240 for releasing the vehicle window or a related system, and a push actuator (not shown). In FIG. 2, the actuator 240 includes components to sever (or snap, in which case the actuator 240 is a snap actuator) the worm screw 235 from the support member 220. Accordingly, the actuator 240 is adapted to snap the worm screw (or other coupling means) with metal snaps 242. Additionally, the worm screw 235 is preferably adapted to snap when a predefined force is applied in a predetermined manner, as provided by the actuator 240 and snaps 242. This can be accomplished with designed areas of weakness, small explosives, alternative materials, or other means known in the metallic or materials arts. In addition, the release system is adapted to articulate the support member 220, by moving the window 210 off the support member 220 via an actuator, or by independently articulating the worm screw 235, or a combination of support member movements, for example.

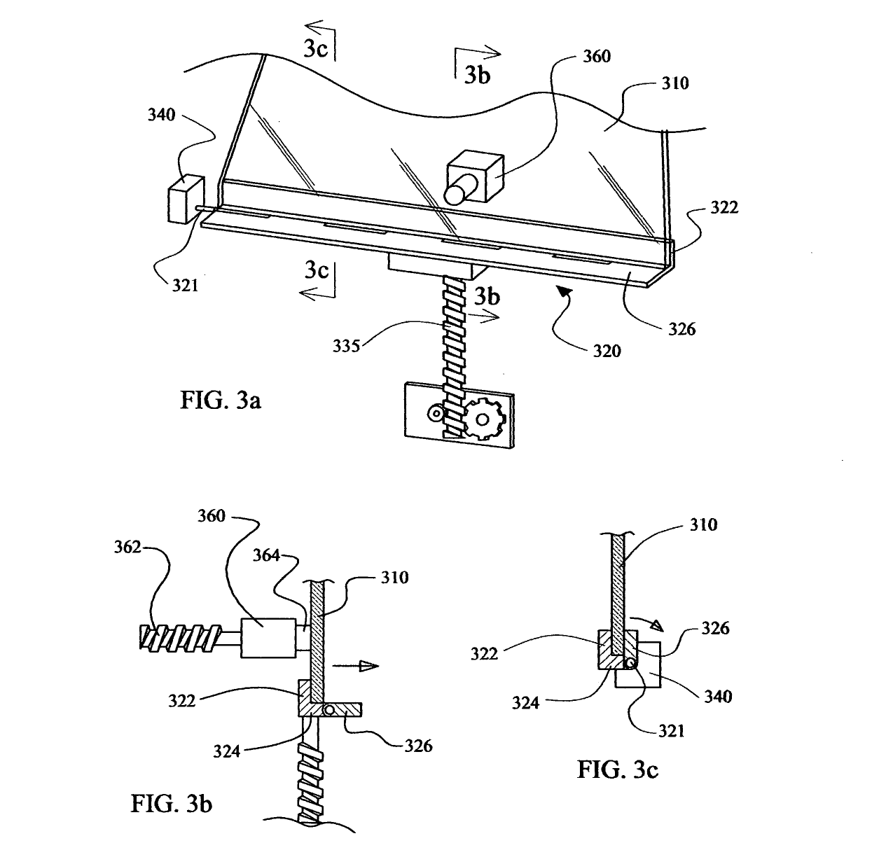

FIGS. 3a through 3c should be read together, where like numerals represent like items. FIG. 3a shows a selected portion a preferred embodiment of a vehicle window system 300, taken to emphasize a support system 320 and a release system that includes an actuator 340 and a push actuator 360. The window system 300 includes a support system 320 having a generally horizontal portion 324 that holds a vehicle window 310, and is also coupled to a worm screw 335. The support system 320 also includes a support member 326 that is adapted to make the vehicle window 310 more easily removable. The support system 320 and selected portions of the release system are illustrated in more detail in FIG. 3b and FIG. 3c.

FIG. 3b provides a cut-view of FIG. 3a taken along cut-line 3b-3b. From this view, it is apparent that the support system 320 includes a lateral support 322 and the generally horizontal portion 324. In an alternative embodiment, the support system 320 includes an adhesive (not illustrated) that provides sufficient support to secure the vehicle window 310 in the support system 320, but “loose” enough to allow the window to be removed from the support system 320 when the window 310 is under user-directed forces. Additionally, the support system 320 includes a hinged support member 326 that is hingedly coupled to the horizontal portion 324 via hinges 321 that are coupled to the release system actuator 340.

Preferably, the hinged support member 326 is held in a position proximate to the vehicle window 310 by the release system 340 and hinges 321, or via a holding means, such as a clip, that can be broken by the release system 340. The removal system includes the actuator 360 which pushes or otherwise moves the vehicle window 310 out of the support system 320 when the hinged support member 326 is in an open position, as shown in FIG. 3b. The actuator 360 includes a push member 364, which may transverse the entire length of the window 310 (for example, as a metallic bar), and also includes an occupant push-portion 362. The occupant push-portion 362 includes a bar that passes from the interior of a motor vehicle and into the push member 364 so that a vehicle occupant can, by pushing on the push portion 362, push the window 310 away from the support system 220.

FIG. 3c shows a close-up of the release system by providing a cut-view of FIG. 3a taken along cut line 3c-3c. Here, it is seen that the hinged support member 326 is coupled to the rigid horizontal portion 324 via hinges 321. Additionally, the hinged support member 326 is further coupled to the release system actuator 340, which may be embodied as a step-actuator. From this view, it is seen that the release system is adapted to articulate the hinged support member 326 substantially away from the vehicle window 310.

Alternatively, the hinged portion 326 may also be removable, so that the hinged support member 326 can be selectively separated from the horizontal portion 324. Accordingly, in one alternative embodiment, the release system actuator 340 and push actuator 360 are adapted to dislocate the hinged support member 326 from the rigid horizontal portion 324 sufficiently to allow the vehicle window 310 to separate from the window support system 320.

The invention can also be characterized as a method of enabling a user to automatically dislocate and remove a vehicle window from a vehicle window frame. In general, the method includes receiving a remote command, and dislocating a window assembly from a window actuating system in response to the remote command. In one embodiment, dislocating breaks a linkage. In an alternative embodiment, dislocating moves a linkage away from a support member. Likewise, the remove command may be received electronically or mechanically.

In an alternative embodiment, the invention is a method of enabling a user to dislocate and remove a window from a motor vehicle. In this embodiment, the method comprises receiving a remove command, and in response to the remove command, articulating a support member so that a window held within the support member may be removed from the support member. In alternative embodiments, articulating moves a hinged portion of the support member, or breaks away a removable portion of the support member. Additionally, the method may further comprise initiating an actuator to remove the window from the support member.

Of course, other features and embodiments of the invention will be apparent to those of ordinary skill in the art. After reading the specification, and the detailed description of the exemplary embodiment, these persons will recognize that similar results can be achieved in not dissimilar ways. Accordingly, the detailed description is provided as an example of the best mode of the invention, and it should be understood that the invention is not limited by the detailed description. Further, it should be understood that the elements of the window system are not limited to the solely described elements, but rather incorporate any functional equivalents. Accordingly, the invention should be read as being limited only by the claims.

Thus, though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

1. A system that alters a window assembly to provide the ability to remove traveling window from a motor vehicle window frame, comprising:
a window support system;
a coupling means attached to the window support system;
a motivator adapted to articulate the coupling means, the coupling means being coupled to the motivator; and
a release system coupled to the window support system.

2. The system of claim 1 further comprising a traveling window disposed in the window support system.

3. The system of claim 2 further comprising a grasping portion disposed about a top portion of the traveling window.

4. The system of claim 1 wherein the release system is adapted to snap the coupling means.

5. The system of claim 1 wherein the release system is adapted to articulate the support member.

6. The system of claim 5 wherein the support member comprises a rigid portion and a hinged member coupled to the rigid portion, the hinged portion further coupled to the release system.

7. The system of claim 6 wherein the release system is adapted to articulate the hinged portion substantially away from the traveling window.

8. The system of claim 5 wherein the support member comprises a rigid portion and a removable portion coupled to the rigid portion and also coupled to the release system.

9. The system of claim 8 wherein the release system is adapted to dislocate the removable portion from the rigid portion sufficiently to allow the traveling window to separate from the window support system.

10. A method of enabling a user to automatically dislocate and remove traveling window from a motor vehicle, comprising:
receiving a remote command; and
in response to the remote command dislocating a window assembly from a window actuating system.

11. The method of claim 10 wherein dislocating breaks a linkage.

12. The method of claim 10 wherein dislocating moves a linkage away from a support member.

13. The method of claim 10 wherein the remove command is received electronically.

14. The method of claim 10 wherein the remove command is received mechanically.

15. A method of enabling a user to dislocate and remove a vehicle window from a motor vehicle window frame comprising:
receiving a remove command; and
in response to the remove command, articulating a support member so that a vehicle window held within the support member in a motor vehicle window frame may be removed from the support member.

16. The method of claim 15 wherein articulating moves a hinged portion of the support member.

17. The method of claim 15 wherein articulating breaks away a removable portion of the support member.

18. The method of claim 15 further comprising initiating an actuator to remove the window from the support member.
